(19) United States
(12) Patent Application Publication
(10) Pub. No.: US 2025/0200595 A1
(43) Pub. Date: Jun. 19, 2025

(54) STORE RENTAL SUPPORT DEVICE, STORE RENTAL SUPPORT METHOD, AND RECORDING MEDIUM

(71) Applicant: NEC Corporation, Tokyo (JP)

(72) Inventor: Toshiyuki TSUCHIDA, Tokyo (JP)

(73) Assignee: NEC Corporation, Tokyo (JP)

(21) Appl. No.: 18/907,754

(22) Filed: Oct. 7, 2024

(30) Foreign Application Priority Data
Dec. 15, 2023 (JP) 2023-212054

(51) Int. Cl. G06Q 30/0202; G06Q 30/0645

(52) U.S. Cl. CPC G06Q 30/0202; G06Q 30/0645

(57) ABSTRACT

A store rental support device includes a memory storing instructions; and one or more processors configured to execute the instructions to: acquire operation information of a customer for at least one of a display device and a product shelf installed in a store and lent to a rental destination operator, the display device and the product shelf exhibiting a product by the rental destination operator; detect a response of the customer to each of at least one area of the display device and the product shelf based on the operation information; discriminate whether the response to each of the areas is good or bad based on a detection result; determine a use condition for each of the areas based on whether the response is good or bad; and output the use condition.

This application is based upon and claims the benefit of priority from Japanese Patent Application No. 2023-212054, filed on Dec. 15, 2023, the disclosure of which is incorporated herein in its entirety by reference.

### TECHNICAL FIELD

The present disclosure relates to a store rental support device, a store rental support method, and a program.

### BACKGROUND ART

There is a next-generation store service that sells products by installing, in a store, a next-generation store housing including a signage that displays information related to a product and enables purchase of the product on the Internet and a display shelf that displays a sample of the product. In the next-generation store service, a store in which a next-generation store housing is installed lends a part or all of the next-generation store to another business operator.

In the next-generation store service or the like, when the store of the rental source lends the next-generation store or the like to another business operator, it is desired that the store of the rental source lends the next-generation store or the like to a business operator having a high degree of contribution to the rental source or the like.

International Publication No. 2017/115626 discloses a technique of ranking each store using an evaluation value of each store and a contribution degree according to a profit amount of each store in a facility having a shared space in which a plurality of stores are opened.

### SUMMARY

An object of the present disclosure is to provide a technique for supporting rent of a space to a business operator.

A store rental support device according to an aspect of the present disclosure incudes: an acquisition means that acquires operation information of a customer for at least one of a display device and a product shelf installed in a store and lent to a rental destination operator, the display device and the product shelf exhibiting a product by the rental destination operator; a detection means that detects a response of the customer to each of at least one area of the display device and the product shelf based on the operation information of the customer; a discrimination means that discriminates whether the response to each of the areas is good or bad based on a detection result; a determination means that determines a use condition for each of the areas based on whether the response is good or bad; and an output means that outputs the use condition.

In a store rental support method according to an aspect of the present disclosure, a computer acquires operation information of a customer for at least one of a display device and a product shelf installed in a store and lent to a rental destination operator, the display device and the product shelf exhibiting a product by the rental destination operator, detects a response of the customer to each of at least one area of the display device and the product shelf on a basis of the operation information of the customer, discriminates whether the response to each of the areas is good or bad on a basis of a detection result, determines a use condition for each of the areas on a basis of whether the response is good or bad, and outputs the use condition.

A program according to one aspect of the present disclosure records a program for causing a computer to execute processing of: acquiring operation information of a customer for at least one of a display device and a product shelf installed in a store and lent to a rental destination operator, the display device and the product shelf exhibiting a product by the rental destination operator; detecting a response of the customer to each of at least one area of the display device and the product shelf on a basis of the operation information of the customer; discriminating whether the response to each of the areas is good or bad on a basis of a detection result; determining a use condition for each of the areas on a basis of whether the response is good or bad; and outputting the use condition.

The program may be stored in a non-transitory computer-readable recording medium.

### BRIEF DESCRIPTION OF THE DRAWINGS

FIG. 1 is a diagram illustrating an example of a configuration of a system including a store rental support device;

FIG. 2 is a diagram illustrating an example of a configuration of a next-generation store housing;

FIG. 3 is a block diagram illustrating an example of a functional configuration of a store rental support device;

FIG. 4 is a diagram illustrating an example of an output screen;

FIG. 5 is a flowchart illustrating an operation of the store rental support device; and

FIG. 6 is a diagram illustrating a hardware configuration for implementing the store rental support device according to the present disclosure with a computer and its peripheral devices.

### EXAMPLE EMBODIMENT

Hereinafter, example embodiments of the present disclosure will be described in detail with reference to the drawings.

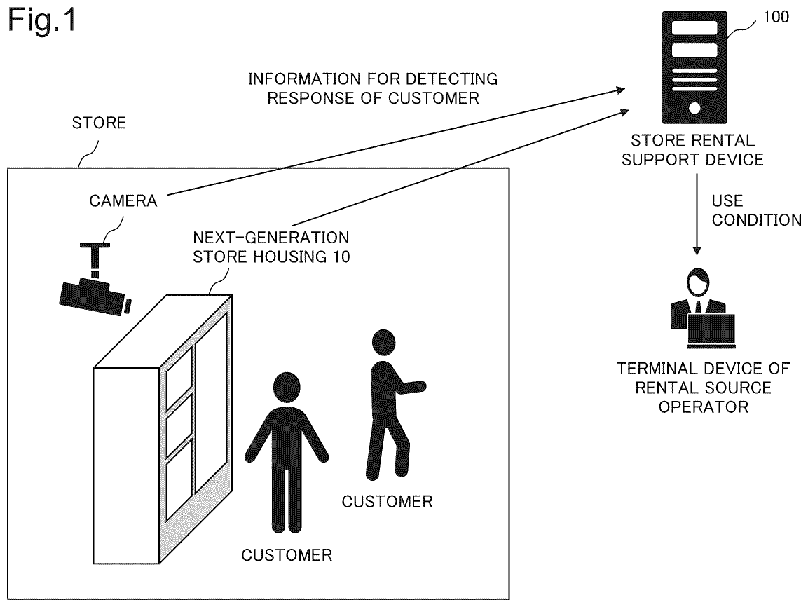

FIG. 1 is a diagram illustrating an example of a configuration of a system including a store rental support device 100 of the present disclosure.

In FIG. 1, the store rental support device 100 is a device that supports rental of a product display means installed in a store to a rental destination operator. The store rental support device 100 acquires the operation information of a customer to the product display means installed in the store, and determines the use condition of the next-generation store housing according to the response of the customer. Then, the store rental support device 100 outputs the determined use condition.

In FIG. 1, the store rental support device 100 is connected to a next-generation store housing 10, a camera, and a terminal device of a rental source operator.

In FIG. 1, the next-generation store housing 10 is an example of a product display means. The next-generation store housing 10 will be described later. The product display means is a means for displaying a product or the like. The product display means is at least one of a shelf on which products are arranged and a display device that displays information regarding the products. The product display means is installed in a store. In the present disclosure, in particular, it is assumed that a part or all of the product display means installed in the store is lent to another business operator different from the business operator who runs the store. For example, the product display means advertises or sells a product different from a product normally handled in the store by another business operator different from the business operator who runs the store. A business operator who borrows a product display means displays a product or the like on the product display means.

The camera is an example of means for collecting operation information of the customer to the product display means. In FIG. 1, the camera is installed outside the product display means, but the camera may be provided in the product display means.

The terminal device of the rental source operator is a terminal device used by a person in charge of managing the next-generation store housing 10 in the rental source operator. The terminal device may be any device as long as a person in charge of managing the next-generation store housing 10 in the rental source operator can confirm the use condition determined by the store rental support device 100. The terminal device may be, for example, a smartphone, a personal computer, a tablet, or the like, but is not limited to these examples.

Next, the next-generation store housing 10 will be described.

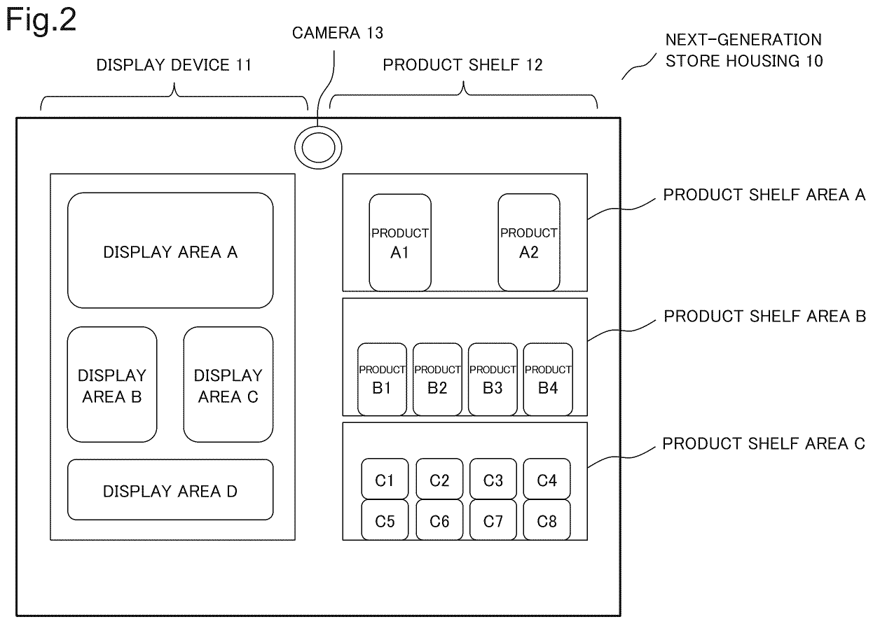

FIG. 2 is an example of a configuration of the next-generation store housing 10. In FIG. 2, the next-generation store housing 10 includes a display device 11, a product shelf 12, and a camera 13.

The display device 11 includes a display unit that displays information regarding a product and information regarding a rental destination operator who borrows the next-generation store housing 10. The display unit of the display device 11 includes one or a plurality of display areas. For example, in FIG. 2, the display unit of the display device 11 includes four display areas (display area A, display area B, display area C, and display area D).

The display unit of the display device 11 may include a touch panel. In this case, the display device 11 may display more detailed information or the like by a touch operation of a customer or the like.

The product shelf 12 is a shelf that displays products, point of purchase (POP) describing information regarding the products, and the like. The product shelf 12 includes one or a plurality of display areas. For example, in FIG. 2, the product shelf 12 includes three product shelf areas (product shelf area A, product shelf area B, and product shelf area C).

The product displayed on the product shelf 12 may be a sample product only for display, or may be a product to be actually sold.

In the next-generation store housing 10, any one of a combination of the display area and the product shelf area, only the display area, or only the product shelf area may be lent out to the rental destination operator. The rental destination operator pays a fee to the rental source operator, borrows at least a part of the display area and the product shelf area, and displays the product. The settlement for selling the displayed product and the delivery of the product may be performed in the next-generation store housing 10, or may be performed in a sales website accessible using a two-dimensional code or the like indicated in the next-generation store housing 10.

Configurations such as sizes and positions of the display device 11 and the product shelf 12 in the next-generation store housing 10 are not limited to the example of FIG. 2. The size and number of the display areas on the display device 11 and the size and number of the product shelf areas on the product shelf 12 are not limited to the example of FIG. 2. The number of display areas and the number of product shelf areas may be the same or different.

The camera 13 is a camera that captures a video around the next-generation store housing 10, which is an example of the operation information of the customer. The video is a video obtained by photographing a customer around the next-generation store housing 10. As described above, the camera 13 may be provided inside the next-generation store housing 10 or outside the next-generation store housing 10 as illustrated in FIG. 1.

Although the next-generation store housing 10 has been described so far, the product display means for which the use condition is to be determined by the store rental support device in the present disclosure is not limited to the next-generation store housing including the display device and the product shelf. In the present disclosure, the product display means may be only a display device, may be a product shelf, or may be a combination of a display device and a product shelf that are separate housings.

Next, a configuration of the store rental support device 100 according to the example embodiment will be described.

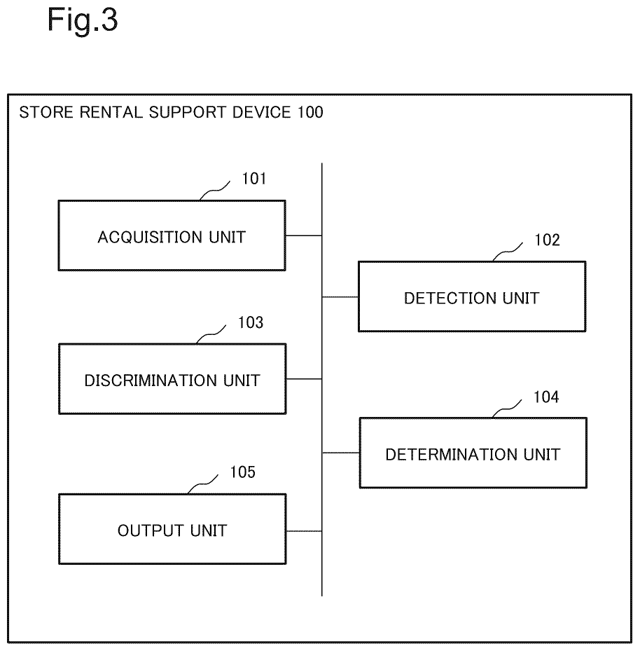

FIG. 3 is a block diagram illustrating an example of a functional configuration of the store rental support device 100. Referring to FIG. 2, the store rental support device 100 includes an acquisition unit 101, a detection unit 102, a discrimination unit 103, a determination unit 104, and an output unit 105.

Next, a configuration of the store rental support device 100 according to a first example embodiment will be described in detail.

In FIG. 3, the acquisition unit 101 is an example of an acquisition means that acquires operation information of a customer for at least one of a display device and a product shelf.

At least one of the display device and the product shelf is the product display means described above. The product display means is installed in a store. Here, the product display means may be installed in the store or may be installed around the store. The product display means is a means that is lent to a rental destination operator and the rental destination operator displays a product. The product display means is managed by a rental source operator. The rental source operator is, for example, a business operator who operates a store where the product display means is installed.

The operation information of the customer is information indicating the operation of the customer with respect to the product display means. For example, the operation information of the customer may be a video obtained by photographing a customer around the product display means. In this case, the acquisition unit 101 may acquire the image from the camera. For example, the operation information of the customer may be an operation history of the display device including a touch panel in the product display means. In this case, the acquisition unit 101 may acquire the operation history of the customer from the display device. The operation history may be information indicating a button selected on the touch panel by a person such as a customer. The operation history may be information indicating an image enlarged or reduced on the touch panel by a person such as a customer.

The operation information of the customer may be at least one of a video and an operation history of a touch panel of the customer.

Next, the detection unit 102 is an example of a detection means that detects a response of the customer to each of at least one area of the display device and the product shelf based on the operation information of the customer. The area of the display device and the area of the product shelf may be an area used by the business operator at the rental destination as one area, or may be a predetermined area.

The response of the customer indicates whether the customer has an interest in the product display means and how much the customer has an interest in the product display means. The response of the customer is a customer's action or customer's feeling toward at least one of the display device and the product shelf.

For example, the detection unit 102 detects the customer's action and the customer's feeling based on a video obtained by photographing the customer around the product display means. The detection unit 102 may detect these response of the customers using a known method for detecting a motion of a person using a video.

An example of the response of the customer detected by the detection unit 102 will be described. For example, the response of the customer is an operation in which the customer looks at the product display means. For example, the detection unit 102 detects which area of the product display means the customer has looked at by detecting the line of sight or detecting the direction of the face using the video. For example, the detection unit 102 may detect that the customer has looked at the product display means when the operation of looking at the product display means is continuously performed for a predetermined time or more such as 3 seconds or more. The detection unit 102 may detect which area and how much the customer has looked at the product display means. The degree may be, for example, the time when the customer looks at the product display means, whether the customer has turned his/her body to the product display means, or whether the customer stays in front of the product display means.

For example, the response of the customer is an operation for the customer to look at an exhibit displayed on the product display means in more detail. The operation of the customer to look at the exhibit displayed on the product display means in more detail is, for example, an operation of touching the exhibit. The operation in which the customer touches the exhibit is, for example, an operation of operating the display device or an operation of picking up the product displayed on the product shelf. The operation of the customer to look at the exhibit displayed on the product display means in more detail may be reading of a two-dimensional code or the like for displaying information regarding the product displayed on the display device or the product shelf. The detection unit 102 may detect access to the two-dimensional code or the like by detecting an operation of holding a terminal device or the like such as a smartphone over the two-dimensional code of the customer in the video.

For example, the response of the customer is an operation in which a customer who has responded to the product display means purchases a product to be sold at a store where the product display means is installed. The detection unit 102 may track a customer who has responded to the product display means in a video obtained by photographing the inside of the store, and detect whether the customer who has responded to the product display means has purchased the product in the store. A known method may be used to track the person in the video.

For example, the response of the customer may be a change in the facial expression of the customer who has operated on the product display means. The detection unit 102 may detect the facial expression of the customer who has operated with respect to the product display means from the video using a known method.

The detection unit 102 may detect a response of the customer by using operation information of the customer other than the video.

For example, the detection unit 102 may detect a response of the customer based on an operation history of the display device that is a touch panel among the product display means. Based on the operation history, the detection unit 102 may detect an operation of operating the display device, which is an operation of the customer to look at an exhibit displayed on the product display means in more detail. For example, the detection unit 102 may detect an operation of purchasing a product displayed on the product display means by the customer based on the operation history.

For example, the detection unit 102 may detect the response of the customer based on an access history to the two-dimensional code displayed on the product display means. For example, the detection unit 102 may detect that the customer accesses the two-dimensional code based on the access history to the two-dimensional code. The detection unit 102 may detect that the customer has registered a product as a favorite product or has purchased a product on a website to which the customer has accessed by the two-dimensional code based on an operation history on the website accessed by the two-dimensional code displayed on the product display means. In these cases, the acquisition unit 101 may acquire an access history to the two-dimensional code displayed on the product display means and an operation history on the website accessed by the two-dimensional code displayed on the product display means from a server or the like that provides the website.

The response of the customer and the operation information of the customer are not limited to these examples. The detection unit 102 may detect one or a plurality of responses among the various response of the customers described above.

The detection unit 102 may further detect the attribute of the customer who has responded to the product display means. For example, the detection unit 102 detects the attribute of the customer who has responded to the product display means based on the information input by the customer in the video or the operation history of the display device.

Next, the discrimination unit 103 is an example of a discrimination means that discriminates whether the response of the customer to each of at least one area of the display device and the product shelf is good or bad based on the detection result of the detection unit 102.

The quality of the response of the customer may be discriminated by, for example, the customer's interest in the product display means and contribution of the product display means to the store. The contribution to the store by the product display means is a profit brought to the store by installing the product display means. The profit brought to the store by installing the product display means is, for example, attraction of customers and improvement of sales.

The discrimination unit 103 may discriminate whether the response of the customer is good or bad not only in two stages of whether the response of the customer is good, but also in a plurality of stages, or in a numerical value indicating whether the response of the customer is good or bad. For example, the discrimination unit 103 discriminates whether the response of the customer detected by the detection unit 102 is good or bad by using discrimination criteria. The discrimination criteria may be determined in advance or may be determined according to statistics of response of the customers. The discrimination criteria may be determined for each area. The discrimination criteria determined for each area may be determined according to the size of the area or the position of the area, for example.

For example, the discrimination unit 103 may discriminate whether the response of the customer is good or bad by using the number of customers who have responded to the product display means. For example, the discrimination unit 103 discriminates that the response of the customer is better as the number of customers who have responded to the product display means increases.

The discrimination unit 103 may discriminate whether the response of the customer is good or bad by using the attribute of the customer who has responded to the product display means. For example, the discrimination unit 103 may discriminate whether the customer has responded by using the number of customers having a specific attribute among the customers who have responded to the product display means. In this case, the specific attribute for which the discrimination unit 103 discriminates whether the response is good or bad may be, for example, an attribute that the store wishes to attract customers, and may be appropriately determined. For example, the discrimination unit 103 may discriminate whether the response of the customer is good or bad by using the similarity between the ratio of the attribute of the customer who has responded to the product display means and the ratio of the attribute as the discrimination criterion. In this case, the discrimination unit 103 may discriminate that the response of the customer is better as the similarity is higher. The ratio of the attribute as the discrimination criterion may be, for example, a ratio of the attribute attracted by a store or the like, and may be appropriately determined.

The discrimination unit 103 may discriminate whether the response of the customer is good or bad according to the operation of the customer with respect to the product display means. For example, the discrimination unit 103 may discriminate whether the response of the customer is good or bad based on the presence or absence and the number of times of one specific operation of the customer with respect to the product display means. For example, the discrimination unit 103 may discriminate whether the response of the customer is good or bad based on the presence or absence and the number of times of a plurality of types of operations of the customer with respect to the product display means. In this case, for example, the discrimination unit 103 may calculate the magnitude of the response of the customer by summing values obtained by multiplying each of the plurality of operations of the customer by a weight. The weight is set, for example, according to the degree of interest in the product display means of each operation. In this case, the discrimination unit 103 may discriminate that the response of the customer is better as the calculated value is greater. The order of the operations of the customer estimated to have a great interest in the product display means may be, for example, an operation in which the customer purchases a product, an operation in which the customer touches an exhibit of the product display means, an operation in which the customer stays in front of the product display means, an operation in which the customer directs his/her body toward the product display means, an operation in which the customer directs his/her face toward the product display means, an operation in which the customer directs his/her line of sight toward the product display means, and the like in the descending order of interest. The weight indicating the degree of interest in the product display means for each operation of the customer may be appropriately determined according to such order.

The discrimination unit 103 may discriminate whether the response is good or bad in response to the customer who has responded to the product display means purchasing the product to be sold in the store where the product display means is installed. The product to be sold in the store is a product different from the product being displayed or sold in the product display means. For example, the discrimination unit 103 may discriminate that the response of the customer is better as the number of customers increases who have responded to the product display means and have purchased the product to be sold in the store where the product display means is installed. The discrimination unit 103 may discriminate that the response of the customer is better as the amount of purchase of the product sold in the store where the product display means is installed is increased by the customer who has responded to the product display means. As a result, it is possible to determine that the response of the customer is good when there is a positive influence on the sales of the store by installing the product display means in the store.

The discrimination unit 103 may discriminate whether the response of the customer is good or bad according to the change in the facial expression of the customer with respect to the product display means. For example, the discrimination unit 103 may discriminate that the response of the customer is better as the number of customers whose facial expression changes to be good is increased. The facial expression being good means, for example, a smile or a facial expression of earnest looking.

The discrimination unit 103 may discriminate whether the response of the customer is good or bad by using the operation information of the customer acquired by the acquisition unit 101 or a learned model obtained by learning the response of the customer detected by the detection unit 102 and whether the response of the customer is good or bad. In a case where the discrimination unit 103 discriminates whether the response of the customer is good or bad by using a learned model obtained by learning the operation information of the customer acquired by the acquisition unit 101 and whether the response of the customer is good or bad, the detection unit 102 may not be provided.

Although the example of the method for determining whether the response of the customer is good or bad has been described, the method for determining whether the response of the customer is good or bad is not limited to these examples, and what kind of response of the customer is discriminate to be good may be appropriately determined.

The determination unit 104 is an example of a determination means that determines the use condition for each area of at least one of the display device and the product shelf based on whether the response discriminated by the discrimination unit 103 is good or bad.

The use condition is a condition when the rental destination operator uses the product display means. The use condition may be, for example, a condition for new rental or a condition for updating the use. The condition for updating the use is determined for each rental destination operator. The condition for new rental is, for example, a use fee. The conditions for updating the use may be the priority of the update, the presence or absence of the right of the update, the use fee at the time of the update, the updatable period, the size and position of the area at the time of the update, and the like.

First, an example of determining a condition for new rental will be described. For example, the determination unit 104 may determine the condition for new rental according to an area such that the condition becomes better for the rental source operator as the response of the customer to at least one area of the display device and the product shelf is better. For example, the determination unit 104 may determine the use fee of the area where the response of the customer is good to be high and may determine the use fee of the area where the response of the customer is bad to be low. As a result, it is considered that the demand increases in the area where the response of the customer is easily obtained, and thus, the determination unit 104 can set the use condition according to the demand.

For example, the determination unit 104 may determine the condition for new rental by referring to a table that defines the relationship between the good or bad response and the condition for new rental. For example, the determination unit 104 may determine the condition for new rental by using a learned model that has learned whether the response is good or bad and the condition for new rental.

Next, an example of determining the condition for updating the use will be described.

For example, the determination unit 104 may determine the condition for updating the use such that the condition becomes better for the rental destination operator as the response of the customer to at least one area of the display device and the product shelf is better. For example, the determination unit 104 may determine the condition for updating the use such that the condition becomes better for the rental destination operator as the response of the customer to at least one area of the display device and the product shelf is worse.

In the example of determining the condition for updating the use, whether to set a good condition or a bad condition for the rental destination operator according to the good or bad response of the customer may be determined for each type of the use condition. For example, the use fee at the time of the update, the priority of the update, the presence or absence of the right of the update, and the updatable period may be determined to be a good condition for the rental destination operator in a case where the customer shows a good response, and the size and position of the area at the time of the update may be determined to be a good condition for the rental destination operator in a case where the customer shows a bad response, but the present disclosure is not limited to these examples.

For example, the determination unit 104 may determine the condition for updating the use by referring to a table that defines the relationship between the good or bad response and the condition for updating the use. For example, the determination unit 104 may determine the condition for updating the use by using a learned model obtained by learning the good or bad response and the condition for updating the use.

The output unit 105 is an example of an output means that outputs the use condition determined by the determination unit 104. The output unit 105 may output the condition for new rental for each area. The output unit 105 may output a condition for updating the use for each rental destination operator. The output unit 105 outputs the determined use condition to, for example, a database that manages the use condition, a terminal device of a rental source operator, or a terminal device of a rental destination operator who borrows a part or all of the product display means. The output method by the output unit 105 is, for example, recording in a database or the like, display on a display device, or sound output to a sound output device, but is not limited to these examples.

The output unit 105 may output the response of the customer and the good or bad response of the customer used to determine the use condition together with each use condition.

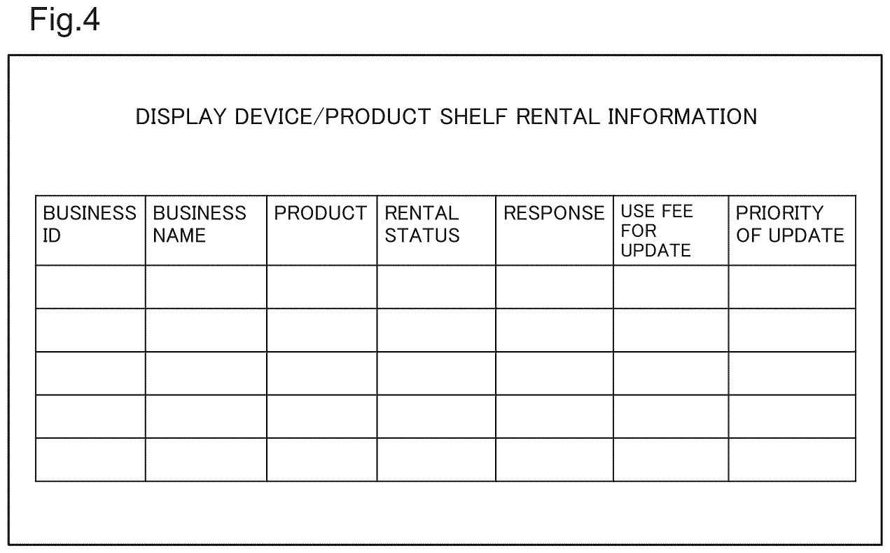

FIG. 4 is a diagram illustrating an example of an output screen for outputting a condition for updating the use for each rental destination operator. The output screen of FIG. 4 is an example of output to the terminal device of the rental source operator by the output unit 105. As described above, the output screen includes the use fee at the time of the update and the priority of the update as the use condition. The output screen includes information indicating the response of the customer to the current exhibit as described above. The output screen includes a business identifier (ID) of the rental destination operator and a business name of the rental destination operator as information for identifying the rental destination operator. The output screen includes, as the current state of the rental destination operator, a product being displayed and a rental status indicating an area being lent out.

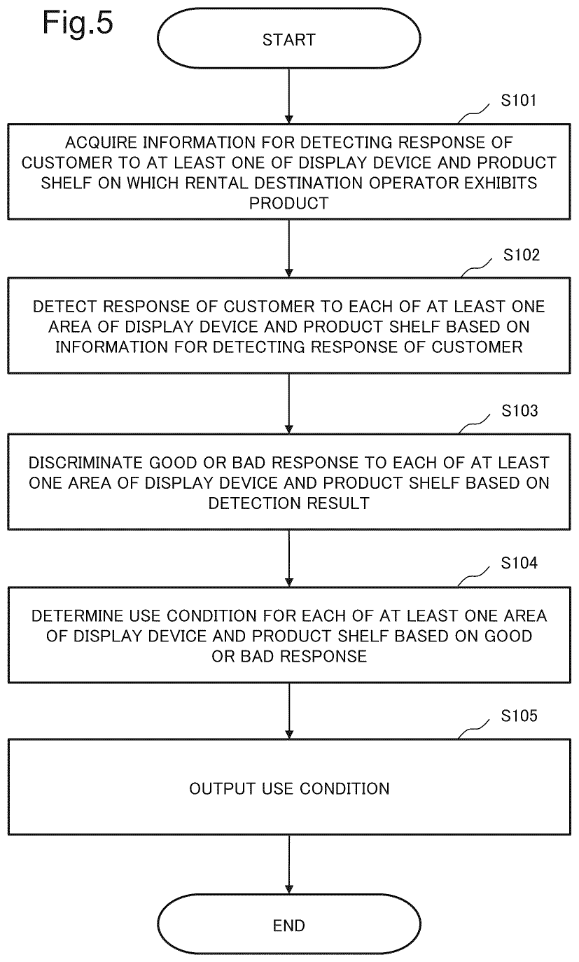

The operation of the store rental support device 100 configured as described above will be described with reference to the flowchart of FIG. 5.

As illustrated in FIG. 5, first, the acquisition unit 101 acquires operation information of a customer for at least one of a display device on which a rental destination operator exhibits a product and a product shelf (step S101).

Next, based on the operation information of the customer, the detection unit 102 detects a response of the customer to each of at least one area of the display device and the product shelf (step S102).

Next, the discrimination unit 103 discriminates whether the response to each of at least one area of the display device and the product shelf is good or bad based on the detection result in step S102 (step S103).

Next, the determination unit 104 determines the use condition for each area of at least one of the display device and the product shelf based on the good or bad response discriminated in step S103 (step S104).

Then, the output unit 105 outputs the use condition determined in step S104 (step S105).

As described above, the store rental support device 100 ends a series of operations.

The store rental support device according to the present example embodiment described above includes an acquisition unit, a detection unit, a discrimination unit, a determination unit, and an output unit. The acquisition unit is installed in a store, is lent out to a rental destination operator, and acquires operation information of a customer for at least one of a display device and a product shelf on which a product is displayed by the rental destination operator. The detection unit detects a response of the customer to each of at least one area of the display device and the product shelf based on the operation information of the customer. The discrimination unit discriminates whether the response to each of the areas is good or bad based on the detection result. The determination unit determines the use condition for each area based on the good or bad response. The output unit outputs the use condition.

As a result, the store rental support device according to the present example embodiment can support rental of a space to a business operator. For example, the store rental support device according to the present example embodiment can more appropriately set use conditions such as a use fee for renting a next-generation store housing installed in a store.

In order to lend a next-generation store to a business operator having a high degree of contribution to a rental source or the like, there is a need to appropriately set use conditions such as a use fee for rental of a next-generation store.

The store rental support device according to the present example embodiment can support rental of a space to a business operator.

### [Modifications]

In determining the condition for updating the use, the determination unit 104 may use information regarding the presence or absence of a rental destination operator who wishes to use at least one of the display device and the product shelf.

For example, the determination unit 104 may determine a condition for new rental according to the presence or absence of a rental destination operator who wishes to use at least one of the display device and the product shelf. For example, in a case where there are many rental destination operators who wish to use at least one of the display device and the product shelf, the determination unit 104 may determine a condition for new rental to be a good condition for the rental source operator. For example, in a case where there are few rental destination operators who wish to use at least one of the display device and the product shelf, the determination unit 104 may determine a condition for new rental to be a good condition for the rental destination operator.

For example, the determination unit 104 may determine whether to set a good condition or a bad use condition for the rental destination operator according to the good or bad response of the customer according to the presence or absence of the rental destination operator who wishes to use at least one of the display device and the product shelf. For example, in a case where there is a rental destination operator who wishes to use at least one of the display device and the product shelf, the determination unit 104 may determine a better condition for the rental source operator as the response of the customer is better. For example, in a case where there is no rental destination operator who wishes to use at least one of the display device and the product shelf, the determination unit 104 may determine a better condition for the rental destination operator as the response of the customer is better.

In the determination of the condition for updating the use, it is possible to determine the use condition according to the demand of the product display means by using the information regarding the presence or absence of the rental destination operator who desires to use at least one of the display device and the product shelf. For example, even in a case where the response of the rental destination operator (customer) who currently borrows the product display means is not good for the area, in a case where there is no other rental destination operator to borrow, continuous borrowing of the rental destination operator may be good for the rental source operator. On the other hand, in a case where the response of the rental destination operator (customer) who currently borrows the product display means is not good for the area, and there is another rental destination operator who intends to borrow the product display means, the rental source operator may wish the rental destination operator (customer) whose response is good to lend the area. In this manner, when determining the condition for updating the use, the determination unit 104 can determine a more appropriate use condition according to the demand of the product display means by using the information regarding the presence or absence of the rental destination operator who desires to use the product display means.

[Hardware Configuration]

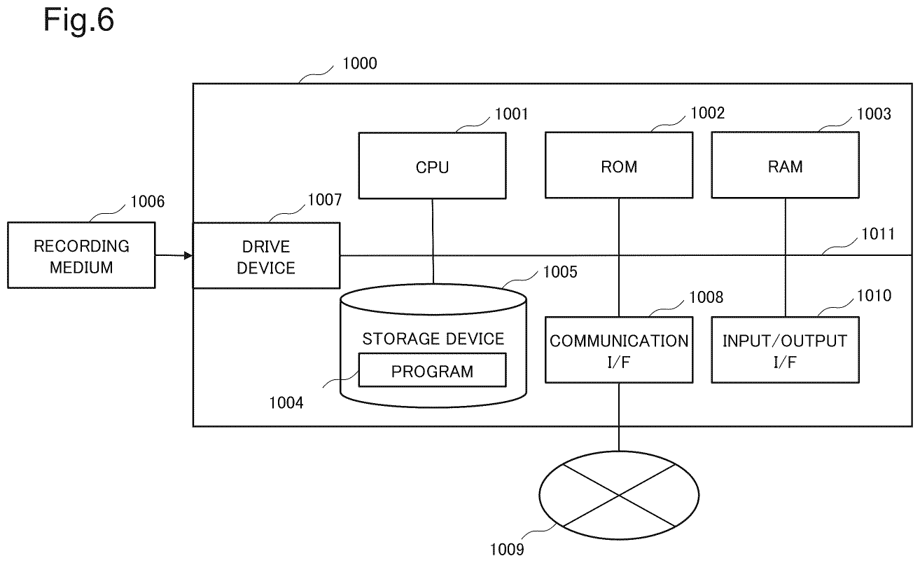

A part or all of each component of each apparatus or system in each example embodiment of the present disclosure described above is achieved by, for example, any combination of an information processing apparatus 1000 and a program as illustrated in FIG. 6. As an example, the information processing apparatus 1000 includes the following configurations.
CPU (Central Processing Unit) 1001.
ROM (Read Only Memory) 1002.
RAM (Random Access Memory) 1003
Program 1004 loaded into RAM 1003
Storage device 1005 storing program 1004
Drive device 1007 for reading recording medium 1006
Communication I/F 1008 connected to communication network 1009
Input/output I/F 1010 for inputting/outputting data
Bus 1011 connecting each component
The I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method of achieving each device. For example, each device or system may be achieved by any combination of the information processing apparatus 1000 and the program separate for each component. A plurality of components included in each device may be achieved by any combination of one information processing apparatus 1000 and a program.

Some or all of the components of each device or system are achieved by general-purpose or dedicated circuitry including a processor or the like, or a combination thereof. The circuit is, for example, a CPU, a graphics processing unit (GPU), a field programmable gate array (FPGA), or a large scale integration (LSI) for artificial intelligence (AI) processing. These may be configured by a single chip or may be configured by a plurality of chips connected via a bus. Some or all of the components of each device may be achieved by a combination of the above-described circuit and the like and a program.

In a case where some or all of the components of each device or system are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client server system or a cloud computing system.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

It will be understood by those of ordinary skill in the art that various changes in form and details may be made therein without departing from the spirit and scope of the present disclosure as defined by the claims.

Although the plurality of operations is described in order in the form of a flowchart, the order of description does not limit the order of executing the plurality of operations. Therefore, when each example embodiment is implemented, the order of the plurality of operations may be changed within a range that does not interfere with the content.

Further, it is noted that the inventor's intent is to retain all equivalents of the claimed invention even if the claims are amended during prosecution.

### Supplementary Note

Some or all of the above example embodiments may be described as the following Supplementary Notes, but are not limited to the following.

### [Supplementary Note 1]

A store rental support device including:
an acquisition means that acquires operation information of a customer for at least one of a display device and a product shelf installed in a store and lent to a rental destination operator, the display device and the product shelf exhibiting a product by the rental destination operator;
a detection means that detects a response of the customer to each of at least one area of the display device and the product shelf based on the operation information of the customer;
a discrimination means that discriminates whether the response to each of the areas is good or bad based on a detection result;
a determination means that determines a use condition for each of the areas based on whether the response is good or bad; and
an output means that outputs the use condition.

### [Supplementary Note 2]

The store rental support device according to Supplementary Note 1, in which the use condition is a use condition for the rental destination operator who has lent the area.

### [Supplementary Note 3]

The store rental support device according to Supplementary Note 1 or 2, in which
the determination means determines a use condition for new rental for the rental destination operator for each of the areas as a use condition for each of the areas based on a response of the customer.

### [Supplementary Note 4]

The store rental support device according to any one of Supplementary Notes 1 to 3, in which
the determination means determines in such a way that the use condition becomes better for the rental destination operator as a response of the customer is better with respect to an exhibit of the area lent to the rental destination operator.

### [Supplementary Note 5]

The store rental support device according to any one of Supplementary Notes 1 to 4, in which
the determination means determines in such a way that the use condition becomes better for the rental source operator as a response of the customer is better with respect to the area.

### [Supplementary Note 6]

The store rental support device according to any one of Supplementary Notes 1 to 6, in which
the discrimination means discriminates that a response of a customer is better as a response of the customer is great with respect to the area.

### [Supplementary Note 7]

The store rental support device according to Supplementary Note 6, in which
a response of the customer to the area is at least one of a line of sight of a customer facing the area, a customer staying in front of the area, operating the area of the display device, and picking up a product displayed on the product shelf.

### [Supplementary Note 8]

The store rental support device according to any one of Supplementary Notes 1 to 7, in which
the discrimination means discriminates that a response of the customer is better as a matching degree between a ratio of an attribute of a customer showing a response to the area and a ratio of an attribute set by the rental source operator is higher.

### [Supplementary Note 9]

The store rental support device according to any one of Supplementary Notes 1 to 8, in which
the discrimination means discriminates that a response of the customer is better as a number of customers who have purchased a product in a store of the rental source operator in which at least one of the display device and the product shelf is installed increases, among customers shown a response to the area.

### [Supplementary Note 10]

The store rental support device according to any one of Supplementary Notes 1 to 9, in which
the determination means determines the use condition based on information indicating whether the response is good or bad and presence or absence of a business operator who wishes to rent the area.

### [Supplementary Note 11]

The store rental support device according to any one of Supplementary Notes 1 to 10, in which
the determination means determines the use condition based on a response of the customer and rental wish information that is information of an exhibit of a business operator who wishes to rent the area.

### [Supplementary Note 12]

The store rental support device according to any one of Supplementary Notes 1 to 11, in which
the operation information of the customer is a video obtained by photographing the customer around a display device or a shelf.

### [Supplementary Note 13]

The store rental support device according to any one of Supplementary Notes 1 to 12, in which
the operation information of the customer is information indicating an operation history of a display device.

### [Supplementary Note 14]

The store rental support device according to any one of Supplementary Notes 1 to 13, in which
the use condition is an update condition that is a use condition in a case where rental of the area to the rental destination operator is updated.

### [Supplementary Note 15]

The store rental support device according to Supplementary Note 14, in which
the update condition is at least one of a priority of the update, availability of the update, and a fee for the update.

### [Supplementary Note 16]

A store rental support method by a computer, the store rental support method including:
acquiring operation information of a customer for at least one of a display device and a product shelf installed in a store and lent to a rental destination operator, the display device and the product shelf exhibiting a product by the rental destination operator;
detecting a response of the customer to each of at least one area of the display device and the product shelf on a basis of the operation information of the customer;
discriminating whether the response to each of the areas is good or bad on a basis of a detection result;
determining a use condition for each of the areas on a basis of whether the response is good or bad; and
outputting the use condition.
   [Supplementary Note 17] A program for causing a computer to execute:
acquiring operation information of a customer for at least one of a display device and a product shelf installed in a store and lent to a rental destination operator, the display device and the product shelf exhibiting a product by the rental destination operator;
detecting a response of the customer to each of at least one area of the display device and the product shelf on a basis of the operation information of the customer;
discriminating whether the response to each of the areas is good or bad on a basis of a detection result;
determining a use condition for each of the areas on a basis of whether the response is good or bad; and
outputting the use condition.

Some or all of the configurations described in Supplementary Notes 2 to 15 dependent on the store rental support device of Supplementary Note 1 described above can also be dependent on the store rental support method of Supplementary Note 16 and the program of Supplementary Note 17 by the same dependency relationship as Supplementary Notes 2 to 15. Some or all of the configurations described as the supplementary notes can similarly be dependent on not only Supplementary Notes 1, 16, and 17, but also various pieces of hardware, software, and various recording medium for recording software, or a system without departing from the above-described embodiments.

1. A store rental support device comprising:
a memory storing instructions; and
one or more processors configured to execute the instructions to:
acquire operation information of a customer for at least one of a display device and a product shelf installed in a store and lent to a rental destination operator, the display device and the product shelf exhibiting a product by the rental destination operator;
detect a response of the customer to each of at least one area of the display device and the product shelf based on the operation information;
discriminate whether the response to each of the areas is good or bad based on a detection result;
determine a use condition for each of the areas based on whether the response is good or bad; and
output the use condition.

2. The store rental support device according to claim 1, wherein
the use condition is a use condition for the rental destination operator who has lent the area.

3. The store rental support device according to claim 1, wherein
the use condition for each of the areas is a use condition for new rental to the rental destination operator for each of the areas.

4. The store rental support device according to claim 1, wherein
the one or more processors are further configured to execute the instructions to:
determine in such a way that the use condition becomes better for the rental destination operator as a response of the customer is better with respect to an exhibit of the area lent to the rental destination operator.

5. The store rental support device according to claim 1, wherein
the one or more processors are further configured to execute the instructions to:
determine in such a way that the use condition becomes better for the rental source operator, the rental source operator being a business operator lending at least one of the display device and the product shelf, as a response of the customer is better with respect to the area.

6. The store rental support device according to claim 1, wherein
the one or more processors are further configured to execute the instructions to:
discriminate that a response of a customer is better as a response of the customer with respect to the area is greater.

7. The store rental support device according to claim 6, wherein
a response of the customer to the area is at least one of a line of sight of a customer facing the area, a customer staying in front of the area, operating the area of the display device, and picking up a product displayed on the product shelf.

8. The store rental support device according to claim 1, wherein
the one or more processors are further configured to execute the instructions to:
discriminate that a response of the customer is better as a matching degree between a ratio of an attribute of a customer showing a response to the area and a ratio of an attribute set by the rental source operator is higher.

9. The store rental support device according to claim 1, wherein
the one or more processors are further configured to execute the instructions to:
discriminate that a response of the customer is better as a number of customers who have purchased a product in a store of the rental source operator in which at least one of the display device and the product shelf is installed increases, among customers shown a response to the area.

10. The store rental support device according to claim 1, wherein
the one or more processors are further configured to execute the instructions to:
determine the use condition based on information indicating whether the response is good or bad and presence or absence of a business operator who wishes to rent the area.

11. The store rental support device according to claim 1, wherein
the one or more processors are further configured to execute the instructions to:
determine the use condition based on a response of the customer and rental wish information that is information of an exhibit of a business operator who wishes to rent the area.

12. The store rental support device according to claim 1, wherein
the operation information of the customer is a video obtained by photographing the customer around a display device or a shelf.

13. The store rental support device according to claim 1, wherein
the operation information of the customer is information indicating an operation history of a display device.

14. The store rental support device according to claim 1, wherein
the use condition is an update condition that is a use condition in a case where rental of the area to the rental destination operator is updated.

15. The store rental support device according to claim 1, wherein
the update condition is at least one of a priority of the update, availability of the update, and a fee for the update.

16. A store rental support method by a computer, the store rental support method comprising:
acquiring operation information of a customer for at least one of a display device and a product shelf installed in a store and lent to a rental destination operator, the display device and the product shelf exhibiting a product by the rental destination operator;
detecting a response of the customer to each of at least one area of the display device and the product shelf based on the operation information of the customer;
discriminating whether the response to each of the areas is good or bad based on a detection result;
determining a use condition for each of the areas based on whether the response is good or bad; and
outputting the use condition.

17. A non-transitory computer-readable recording medium that records a program for causing a computer to execute:
acquiring operation information of a customer for at least one of a display device and a product shelf installed in a store and lent to a rental destination operator, the display device and the product shelf exhibiting a product by the rental destination operator;
detecting a response of the customer to each of at least one area of the display device and the product shelf based on the operation information of the customer;
discriminating whether the response to each of the areas is good or bad based on a detection result;
determining a use condition for each of the areas based on whether the response is good or bad; and
outputting the use condition.
